(19) United States
(12) Patent Application Publication
(10) Pub. No.: US 2016/0248176 A1
(43) Pub. Date: Aug. 25, 2016

(54) SURGE PROTECTED COAXIAL TERMINATION

(71) Applicant: Corning Optical Communications RF LLC, Glendale, AZ (US)

(72) Inventors: Donald Andrew Burris, Peoria, AZ (US); Thomas Dewey Miller, Peoria, AZ (US)

(21) Appl. No.: 14/795,367

(22) Filed: Jul. 9, 2015

Related U.S. Application Data
(60) Provisional application No. 62/118,684, filed on Feb. 20, 2015.

(51) Int. Cl. H01R 9/05; H01R 13/58

(52) U.S. Cl. CPC H01R 9/05; H01R 13/58

(57) ABSTRACT

A surge-protected coaxial termination includes a metallic outer body, a center conductor extending through a central bore of the outer body, and a spark gap created therebetween to discharge high-voltage power surges. A plurality of dielectric insulators surrounds the center conductor on opposite sides of the spark gap. High impedance inductive zones surround the spark gap to form a T-network low pass filter that nullifies the additional capacitance of the spark gap. An enlarged portion of a center conductor mitigates deleterious effects of arcing. An axial, carbon composition resistor is disposed inside the outer body, and inside the dielectric insulator to absorb the RF signal, and prevent its reflection.

### RELATED APPLICATIONS

This application claims the benefit of priority under 35 U.S.C. §119 of U.S. Provisional Application No. 62/118,684 filed on Feb. 20, 2015, the content of which is relied upon and incorporated herein by reference in its entirety.

### BACKGROUND

1. Field

The present disclosure relates generally to coaxial terminations used to terminate ports that are adapted to receive coaxial cable connectors, and more particularly, to an improved coaxial termination that offers enhanced protection against repeated high-voltage surges.

2. Technical Background

RF coaxial cable systems are used in the cable television industry for distributing radio frequency signals to subscribers of cable television service, and more recently, voice and data telecommunications services. The coaxial cables used to route such signals include a center conductor for transmitting a radio frequency signal, and a surrounding, grounded outer conductive braid or sheath. Typically, the coaxial cable includes a dielectric material surrounding the center conductor and spacing it from the grounded outer sheath. The diameter of the center conductor, and the diameter of the outer conductor, and type of dielectric are selected to produce a characteristic impedance, such as 75 ohms, in the coaxial line. This same coaxial cable is sometimes used to provide AC power (typically 60-90 Vrms) to the equipment boxes that require external power to function.

Within such coaxial cable systems, such coaxial lines are typically coupled at their ends to equipment boxes, such as signal splitters, amplifiers, etc. These equipment boxes often have several internally-threaded coaxial ports adapted to receive end connectors of coaxial cables. If one or more of such coaxial ports is to be left “open”, i.e., a coaxial cable is not going to be secured to such port, then it is necessary to “terminate” such port with a coaxial termination that matches the characteristic impedance of the coaxial line (e.g., a 75 ohm termination). If such a coaxial termination is omitted, then undesired reflected signals interfere with the proper transmission of the desired radio frequency signal.

When deployed in the field, as in cable TV systems, for example, these known coaxial termination devices can be subjected to power surges caused by lightning strikes and other events. These power surges can damage or destroy the resistive and/or capacitive elements in such a termination, rendering it non-functional.

An older specified surge test, ANSI C62.41 Category B3, specified that a 6,000 Volt open circuit/3,000 Amp short circuit surge pulse be injected into the coaxial termination device. At least some of the known coaxial termination devices have difficulty complying with such surge test. Indeed, efforts to make the resistive and capacitive components larger, in order to withstand such power surges, can have the negative impacts of increased costs and/or creating a larger impedance mismatch, and hence, causing poorer levels of RF Return Loss performance. One approach to designing a termination that can withstand the previously mentioned 6,000 Volt surges would be to use a 6,000 Volt capacitor and a high power resistor. Unfortunately, such components are relatively expensive and have a much larger physical size, which tends to increase the size and cost of the housing necessary to contain such components, thereby resulting in a much bulkier and more costly design. In more recent times, a newer surge test (ANSI/SCTE 81 2012) has been introduced by the industry requiring a different test profile as summarized in table 1 below. Older designs such as that related in U.S. Pat. No. 6,751,081 (Kooiman) exhibit severe Return Loss degradation after subjection to this newer surge test profile.

### SUMMARY

Briefly described, and in accordance with various embodiments provided, the present disclosure relates to a surge-protected coaxial termination that includes a metallic outer body having a central bore extending therethrough, a center conductor extending into the central bore of the metallic outer body, and a spark gap created within such coaxial termination for allowing a high-voltage power surge to discharge across the spark gap without damaging other components (e.g., resistive and/or capacitive components) that might also be included in such coaxial termination.

In one embodiment, a surge-protected coaxial termination is provided. The surge-protected coaxial termination includes a metallic outer body having a central bore extending therethrough along a longitudinal axis between first and second ends of the metallic outer body. The central bore is bounded by an inner wall having an inwardly-directed radial step portion extending into the central bore. The inner wall and radial stem together define: a first portion of the central bore disposed on a first side of the radial step, a second orifice portion of the central bore disposed generally at the radial step, and a third portion of the central bore disposed on a second opposing side of the radial step. A center conductor extends into the central bore of the metallic outer body and into each of the first, second and third portions of the central bore. The center conductor further includes a first cylindrical portion disposed at least partially within the first portion of the central bore, a second central portion disposed at least partially within the second orifice portion of the central bore in close proximity to the radial step of the body to form a spark gap therebetween, and a third cylindrical portion disposed at least partially within the third portion of the central bore. The third rearward cylindrical portion of the center conductor is at least partially surrounded by an insulator layer. Air is disposed within at least a portion of the spark gap formed between the radial step of the body and the second central portion of the center conductor.

In another embodiment, a surge-protected coaxial termination is provided. The surge-protected coaxial termination includes a metallic outer body having a central bore extending therethrough along a longitudinal axis between first and second ends of the metallic outer body. The central bore is bounded by an inner wall having an inwardly-directed radial step portion extending into the central bore. The inner wall and the radial step define a first portion of the central bore disposed on a first side of the radial step, and a second orifice portion of the central bore disposed generally at the radial step. A center conductor extends into the central bore of the metallic outer body and into each of the first and second portions of the central bore. The center conductor includes a first cylindrical portion disposed at least partially within the first portion of the central bore, and a second enlarged central portion disposed at least partially within the second orifice portion of the central bore in close proximity to the radial step of the body to form a spark gap therebetween. The second enlarged central portion of the center conductor having an axial length and a diameter. A ratio of the axial length to the diameter of the second enlarged central portion, in some embodiments, is in a range from approximately 0.3 to 1 to approximately 1.3 to 1. Air is disposed within at least a portion of the spark gap formed between the radial step of the body and the enlarged central portion of the center conductor.

Additional features and advantages will be set forth in the detailed description which follows, and in part will be readily apparent to those skilled in the art from that description or recognized by practicing the embodiments as described herein, including the detailed description which follows, the claims, as well as the appended drawings.

It is to be understood that both the foregoing general description and the following detailed description are merely exemplary, and are intended to provide an overview or framework to understanding the nature and character of the claims. The accompanying drawings are included to provide a further understanding, and are incorporated in and constitute a part of this specification. The drawings illustrate embodiments, and together with the description serve to explain principles and operation of the various embodiments.

### BRIEF DESCRIPTION OF THE DRAWINGS

FIG. 1 schematically depicts a cross-sectional view of an example surge protected coaxial termination;

FIG. 1A schematically depicts a detail partial cross-sectional view of a surge protected coaxial termination of FIG. 1;

FIG. 2 schematically depicts a cross-sectional view of an example surge protected coaxial termination, according to one or more embodiments shown and described herein;

FIG. 2A schematically depicts a detail partial cross-sectional view of the surge protected coaxial termination of FIG. 2, according to one or more embodiments shown and described herein;

FIG. 3 schematically depicts a cross-sectional view of another example of a surge protected coaxial termination, according to one or more embodiments shown and described herein;

FIG. 3A schematically depicts a detail partial cross-sectional view of the surge protected coaxial termination of FIG. 3, according to one or more embodiments shown and described herein;

FIG. 4 schematically depicts a detail partial cross-sectional view of yet another example of a surge protected coaxial termination showing an enlarged portion of a contact, according to one or more embodiments shown and described herein;

FIG. 4A schematically depicts a detail partial cross-sectional end view of the surge protected coaxial termination of FIG. 4, according to one or more embodiments shown and described herein;

FIG. 5 schematically depicts a partial cross-sectional view of an example surge protected coaxial terminator mounted in a device, according to one or more embodiments shown and described herein;

FIG. 5A schematically depicts a cross-sectional view an example surge protected coaxial terminator having a bent center conductor, according to one or more embodiments shown and described herein;

FIG. 5B schematically depicts a cross-sectional view of another example surge protected coaxial terminator having a bent center conductor, according to one or more embodiments shown and described herein;

FIG. 6 schematically depicts a partial cross-sectional view of an example surge protected coaxial terminator including a groove in the center conductor that acts as a mechanical strain relief, according to one or more embodiments shown and described herein; and

FIG. 7 schematically depicts a partial cross-sectional view of another example surge protected coaxial terminator including a groove in the center conductor that acts as a mechanical strain relief, according to one or more embodiments shown and described herein.

### DETAILED DESCRIPTION

Embodiments of the present disclosure are directed to a surge-protected coaxial termination that includes a metallic outer body having a central bore extending therethrough, a center conductor extending into the central bore of the metallic outer body, and a spark gap created within such coaxial termination for allowing a high-voltage power surge to discharge across the spark gap without damaging other components (e.g., resistive and/or capacitive components) that might also be included in such coaxial termination.

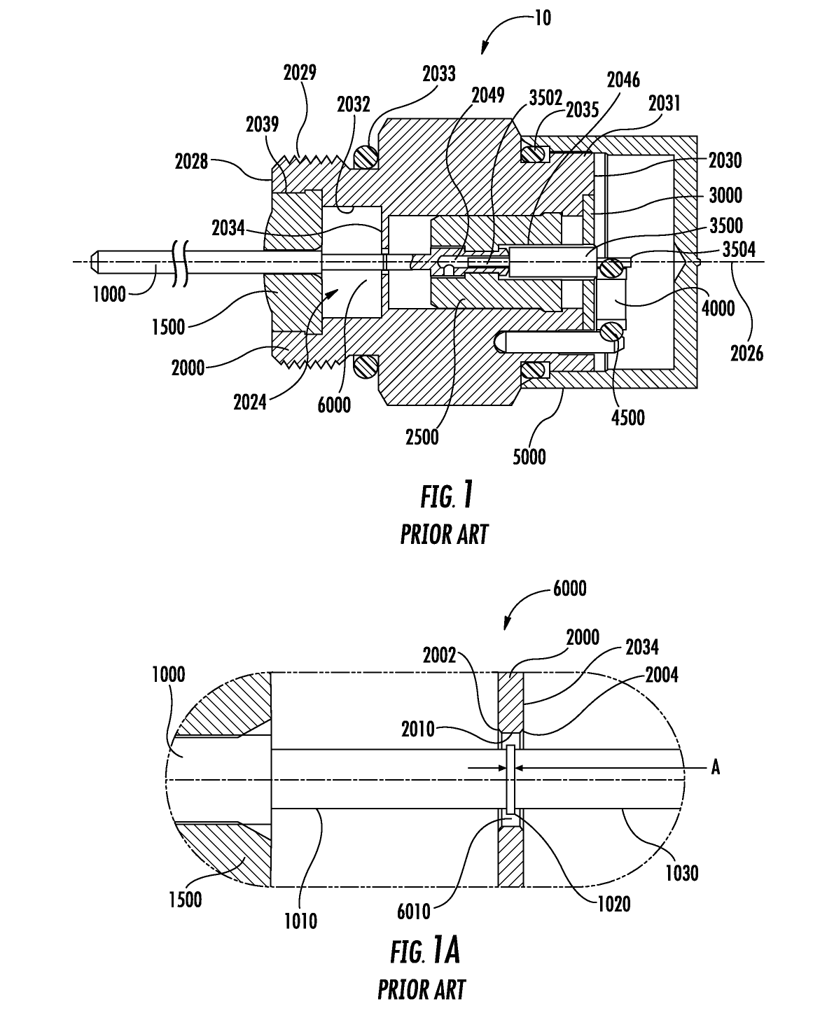

Referring now to FIG. 1, a cross-sectional view of a typical surge protected coaxial termination 10 is shown. The surge protected coaxial termination 10 includes a metallic outer body 2000. The body 2000, for example, may incorporate a hex-shaped outer profile for receiving jaws of a wrench when the surge protected coaxial terminations 10 is tightened onto a coaxial port of a transmission line equipment box. The metallic outer body 2000 includes a central bore 2024, or central passage, extending therethrough along a longitudinal axis 2026 between a first end 2028 and a second end 2030 of the metallic outer body 2000. The central bore 2024 is defined by an inner wall 2032. As shown in FIG. 1, an inwardly-directed radial step 2034 extends from the inner wall 2032 toward the central axis 2026. The step 2034 is relatively short in the sense that its length along the central axis 2026 is very short in comparison with the axial length of the remaining portion of the inner wall 2032. Likewise, the inner diameter of the inner wall 2032 within the step portion 2034 is significantly smaller than the inner diameter of the remaining portion of the inner wall 2032.

As shown in FIG. 1, the first end 2028 of the outer body includes external mounting threads 2029 that may be used to secure the surge protected coaxial termination 10 to an unterminated coaxial port of a transmission line equipment box. An opposing end of the outer body 2000 includes a smooth outer cylindrical surface 2031 to form a press fit for mating with a protective cap 5000. If desired, outer cylindrical surface 2031 can be formed with external threads for mating with internal threads of the protective cap 5000. A pair of O-rings 2033 and 2035 may be used to form a fluid-tight seal between the outer body 2000 and a coaxial port threadably engaged with the external mounting threads 2029 and the protective cap 5000.

A center conductor contact 1000 extends through the central bore 2024 of the outer body 2000. The center conductor contact 1000 is supported at one end thereof by a first supporting insulator 1500. The first supporting insulator 1500 is in turn supported by an enlarged annular bore 2039 formed in the first end 2028 of the outer body 2000. The portion of the center conductor contact 1000 that protrudes outwardly from the first end 2028 of the outer body 2000 can be cut to any desired length by a user. A typical coaxial port of an equipment box includes a clamping mechanism for clamping the center conductor contact 1000 and establishing an electrical connection therewith.

The center conductor contact is also supported at its opposite end by a second supporting insulator 2500 of dielectric material which fits into central bore 2024 from the second end 2030 thereof. The outer diameter of the center conductor contact 1000 may be selected so that, at any point along its length, given the surrounding dielectric characteristics, and given the diameter of the surrounding inner wall, the characteristic impedance of center conductor contact 1000 will be matched with a desired characteristic impedance of the coaxial cable system (e.g., 75 ohms in a 75-ohm characteristic impedance system).

Spark gap area 6000 is shown in greater detail in the enlarged drawing of FIG. 1A. As indicated in FIG. 1A, the center conductor 1000 includes a slightly enlarged diameter within radial step portion 2034 of inner wall 2032 to facilitate the jumping of a spark across spark gap 6010. The dimensions of the spark gap 6010 are selected to effectively insulate grounded radial step 2034 from center conductor 1000 at normal operating voltages and currents, up to a certain threshold voltage (for example, 1500 Volts). When the surge voltage between center conductor 1000 and outer body 2000 exceeds this threshold voltage, the spark gap 6010 will fire and conduct any excess energy to ground. Such an abnormal power surge might be induced by a lightning strike, for example.

The surge protected coaxial termination 10 also includes a resistive terminating element, resistor 3500, coupled between the center conductor 1000 and the grounded outer body 2000. Referring to FIG. 1, axial resistor 3500 is disposed within the central bore 2024 of the outer body 2000. The resistor 3500 is supported within the central bore 2046 of supporting insulator 2500. A first internal electrode 3502 of resistor 3500 is received within a bore 2049 formed in the end of center conductor 1000 that lies within supporting insulator 2500. The electrode may be soldered to center conductor 1000 before center conductor 1000 and resistor 3500 are inserted into supporting insulator 2500. At the opposite end of the resistor 3500, an external solder electrode 3504 protrudes from the outer face of supporting insulator 3000. The value for resistor 3500 is chosen to be compatible with the characteristic impedance of the coaxial line (e.g., 50 ohms, 75 ohms, etc.). The resistor 3500 is the element that absorbs the RF signal to prevent reflection. The resistor 3500 is preferably chosen to be a carbon composition resistor because such resistors offer good high frequency performance, and also have the ability to withstand the surge current that occurs as the capacitor is alternately charged, and then discharged, during surge protection. As mentioned above, any deviation from the characteristic impedance of the coaxial line can cause RF signal reflection; accordingly, the resistor 3500 is strategically placed on the central axis of the coaxial line structure, and surrounding supporting insulators 2500, 3000, and central bore 2024 of the outer body 2000, are designed to maintain the desired characteristic impedance throughout the length of resistor 3500.

A blocking capacitor 4000 in the form of a so-called “chip capacitor”, extends radially between solder electrode 2048 and a second solder electrode 4500, or grounding post, that extends from a recess formed in outer body 2000. The opposing ends (electrodes) of the blocking capacitor 4000 are soldered to electrodes 2048 and post 4500 in order to electrically couple center conductor 1000 in series with the resistor 3500 and the capacitor 4000 to ground (outer body 2000), in parallel with spark gap 6010. Capacitor 4000 is provided to block DC or AC power from flowing through resistor 3500.

FIG. 1A is detail partial cross-sectional view of the surge protected coaxial termination of FIG. 1 including a spark gap area 6000, a center conductor contact 1000, and a body 2000. The center conductor contact 1000 includes a first cylindrical portion 1010, an enlarged diameter portion 1020 having an axial length “A” and a second cylindrical portion 1030. The body 2000 includes a first chamfer 2002, a second chamfer 2004, an orifice 2010 and the radial step 2034. The spark gap are includes a spark gap 6010.

Radial step 2034 of the body 2000 and spark gap 6010, being in close proximity to the center conductor 1000, represent a highly-capacitive discontinuity in the characteristic impedance of the transmission line relative to RF fields traveling therealong, and would normally cause the RF energy to be reflected, contrary to the purpose of the coaxial termination device. Accordingly, high characteristic impedance inductive zones are formed on both sides of reduced-diameter radial step 2034 to create the equivalent of an electrical T-network low pass filter. High impedance zones lie on opposite sides of radial step portion 2034. The amount of additional inductance introduced by high impedance inductive zones is offset the additional capacitance caused by reduced-diameter step portion 2034. The combined effect of such high impedance inductive zones together with the highly-capacitive radial step portion 2034, effectively nullifies the RF signal reflection that would otherwise occur due to radial step 2034 alone.

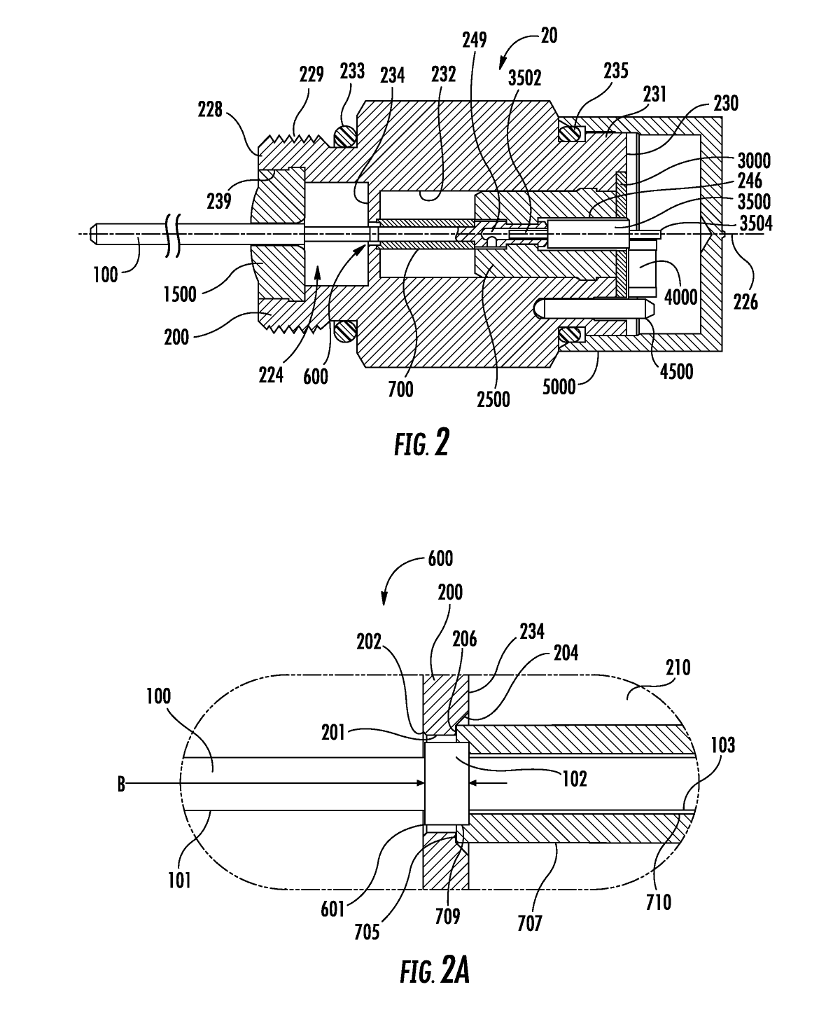

Referring now to FIG. 2, a cross-sectional view illustrates an example embodiment of a surge protected coaxial termination 20. The surge protected coaxial termination 20 comprises a metallic outer body 200. The body 200, for example, may incorporate a hex-shaped outer profile for receiving jaws of a wrench when the surge protected coaxial termination 20 is tightened onto a coaxial port of a transmission line equipment box. The metallic outer body 200 includes a central bore 224, or central passage, extending therethrough along a longitudinal axis 226 between a first end 228 and a second end 230 of the metallic outer body 200. The central bore 224 is defined by an inner wall 232. An inwardly-directed radial step 234 extends from the inner wall 232 toward the central axis 226. The step 234 is relatively short in the sense that its length along the central axis 226 is very short in comparison with the axial length of the remaining portion of the inner wall 232. Likewise, the inner diameter of the inner wall 232 within the step portion 234 is significantly smaller than the inner diameter of the remaining portion of the inner wall 232.

The first end 228 of the outer body includes external mounting threads 229 that may be used to secure the surge protected coaxial termination 20 to an unterminated coaxial port of a transmission line equipment box. An opposing end of the outer body 200 includes a smooth outer cylindrical surface 231 to form a press fit for mating with a protective cap 5000. If desired, outer cylindrical surface 231 can be formed with external threads for mating with internal threads of the protective cap 5000. A pair of O-rings 233 and 235 may be used to form a fluid-tight seal between the outer body 2000 and a coaxial port threadably engaged with the external mounting threads 229 and the protective cap 5000.

A center conductor contact 100 extends through the central bore 224 of the outer body 200. The center conductor contact 100 is supported at one end thereof by a first supporting insulator 1500. The first supporting insulator 1500 is in turn supported by an enlarged annular bore 239 formed in the first end 228 of the outer body 200. The portion of the center conductor contact 100 that protrudes outwardly from the first end 228 of the outer body 200 can be cut to any desired length by a user. A typical coaxial port of an equipment box includes a clamping mechanism for clamping the center conductor contact 100 and establishing an electrical connection therewith.

The center conductor contact 100 is also supported at its opposite end by a second supporting insulator 2500 of dielectric material which fits into central bore 224 from the second end 230 thereof. The outer diameter of the center conductor contact 100 may be selected so that, at any point along its length, given the surrounding dielectric characteristics, and given the diameter of the surrounding inner wall, the characteristic impedance of center conductor contact 100 will be matched with a desired characteristic impedance of the coaxial cable system (e.g., 75 ohms in a 75-ohm characteristic impedance system).

Spark gap area 600 is shown in greater detail in the enlarged drawing of FIG. 2A. As indicated in FIG. 2A, the center conductor 100 includes an enlarged diameter within radial step portion 234 of inner wall 232 to facilitate the jumping of a spark across spark gap 601. The dimensions of the spark gap 601 are selected to effectively insulate grounded radial step 234 from center conductor 100 at normal operating voltages and currents, up to a certain threshold voltage (for example, 1500 Volts). When the surge voltage between center conductor 100 and outer body 200 exceeds this threshold voltage, the spark gap 601 will fire and conduct any excess energy to ground. Such an abnormal power surge might be induced by a lightning strike, for example.

The surge protected coaxial termination 20 also includes a resistive terminating element, resistor 3500, coupled between the center conductor 100 and the grounded outer body 200. Referring to FIG. 2, axial resistor 3500 is disposed within the central bore 224 of the outer body 200. The resistor 3500 is supported within a central bore 246 of supporting insulator 2500. A first internal electrode 3502 of resistor 3500 is received within a bore 249 formed in the end of center conductor 100 that lies within supporting insulator 2500. The electrode 3502 may be soldered to center conductor 100 before center conductor 100 and resistor 3500 are inserted into supporting insulator 2500. At the opposite end of the resistor 3500, an external solder electrode 3504 protrudes from the outer face of supporting insulator 3000. The value for resistor 3500 is chosen to be compatible with the characteristic impedance of the coaxial line (e.g., 50 ohms, 75 ohms, etc.). The resistor 3500 is the element that absorbs the RF signal to prevent reflection. The resistor 3500 is preferably chosen to be a carbon composition resistor because such resistors offer good high frequency performance, and also have the ability to withstand the surge current that occurs as the capacitor is alternately charged, and then discharged, during surge protection. As mentioned above, any deviation from the characteristic impedance of the coaxial line can cause RF signal reflection; accordingly, the resistor 3500 is strategically placed on the central axis of the coaxial line structure, and surrounding supporting insulators 2500, 3000, and central bore 224 of the outer body 200, are designed to maintain the desired characteristic impedance throughout the length of resistor 3500.

A blocking capacitor 4000 in the form of a so-called “chip capacitor”, extends radially between solder electrode 3504 and a second solder electrode 4500, or grounding post, that extends from a recess formed in outer body 200. The opposing ends (electrodes) of the blocking capacitor 4000 are soldered to electrodes 3504 and post 4500 in order to electrically couple center conductor 100 in series with the resistor 3500 and the capacitor 4000 to ground (outer body 200), in parallel with spark gap 601. Capacitor 4000 is provided to block DC or AC power from flowing through resistor 3500.

FIG. 2A depicts a detailed partial cross-sectional view of the surge protected coaxial termination 20 of FIG. 2. In this embodiment, the surge protected coaxial termination 20 includes a center conductor contact 100, a body 200, a spark gap area 600 and an insulator 700. The center conductor contact 100 includes a first forward cylindrical portion 101, a second enlarged central portion 102 having an axial length “B”, and a third rearward cylindrical portion 103. The second enlarged central portion 102 is disposed generally at the spark gap 601, adjacent the inwardly-directed radial step 234 extending from the inner wall 232 of the body 200.

The body 200 also includes an orifice 201, a first forward chamfer 202 disposed at a radial inward portion of the radial step, adjacent the second enlarged central portion of the center conductor contact 102 and generally at the spark gap 601 of the spark gap area. A second chamfer 204 and a face 206 formed along a rearward side of the radial step 234 generally adjacent to the spark gap 601. The face 206 and second rearward facing chamfer of the radial step of the body 200 also support a front end 705 of the insulator 700. A cylindrical portion 707 extends within a bore 210 of the body in rearward direction away from the spark gap 601, radial step of the body and the second enlarged central portion 102 of the center conductor contact 100. The cylindrical portion 707 of the insulator 700 also surrounds, and thus insulates, the third rearward cylindrical portion 103 of the center conductor contact 100 within a passage 710 of the insulator 700 that extends in a rearward direction within the bore 210 extending away from the spark gap 601, radial step of the body and the second enlarged central portion 102 of the center conductor contact 100. The insulator 700 further comprises a counter bore 709 disposed at the front end 705 and adapted to receive and support the second enlarged portion 102 of the center conductor contact 100 adjacent to the spark gap.

An ability to withstand power surges in the surge protected coaxial termination 20 is enhanced by a relatively increased length B as compared to length A shown in FIG. 1A. As electrical arcs jump between the enlarged portion 102 and the orifice 201, the surface of enlarged portion 102 is eroded. As the surface of enlarged portion 102 is eroded the ability to shunt power to ground is decreased and Return Loss is somewhat negatively affected. An increased surface area of the enlarged portion 102 allows for a longer period of time before the ability to shunt power to ground is impacted, thereby increasing a length of time that the Return Loss performance remains stable even after multiple power surges required by the new specification previously noted. Additionally, the insulator 700 provides both improved centering of contact 100 within orifice 201 and protection from the breakdown of enlarged portion 102. The effect on electrical impedance of insulator 700 is offset by lengthening the bore 210 of body 200 in such a manner as to “tune” the RF structure of surge protected coaxial termination 20 to produce the desired Return Loss performance. In testing, a change in Return Loss as compared from a virgin state to the first arc was found to be relatively minor (on the order of approximately 2 dB) and remained relatively stable over the duration of the test thereafter.

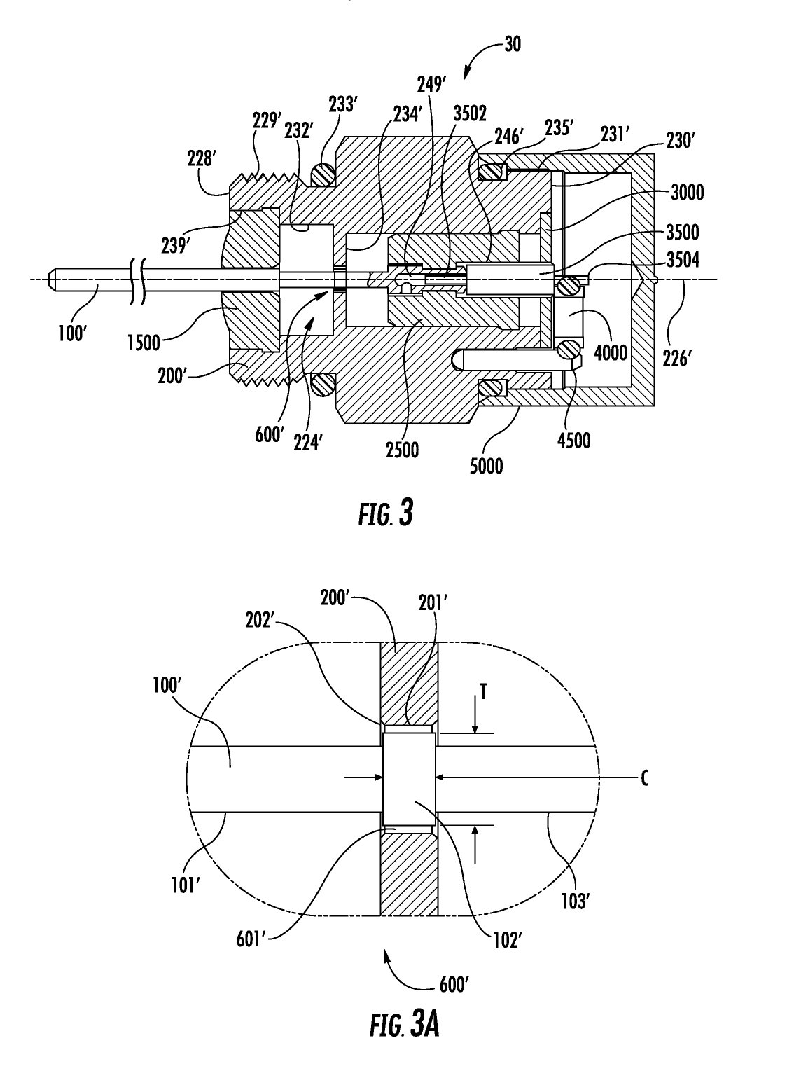

Referring now to FIG. 3, a cross-sectional view of another embodiment illustrating a surge protected coaxial termination 30. The surge protected coaxial termination 30 comprises a metallic outer body 200′. The metallic outer body 200 includes a central bore 224′, or central passage, extending therethrough along a longitudinal axis 226′ between a first end 220′ and a second end 230′ of the metallic outer body 200′. The central bore 224′ is defined by an inner wall 232′. An inwardly-directed radial step 234 extends from the inner wall 232 toward the central axis 226′. The step 234′ is relatively short in the sense that its length along the central axis 226′ is very short in comparison with the axial length of the remaining portion of the inner wall 232′. Likewise, the inner diameter of the inner wall 232′ within the step portion 234′ is significantly smaller than the inner diameter of the remaining portion of the inner wall 232′.

A center conductor contact 100′ extends through the central bore 224′ of the outer body 200′. The center conductor contact 100′ is supported at one end thereof by a first supporting insulator 1500. The first supporting insulator 1500 is in turn supported by an enlarged annular bore 239′ formed in the first end 228′ of the outer body 200′. The portion of the center conductor contact 100′ that protrudes outwardly from the first end 228′ of the outer body 200′ can be cut to any desired length by a user. A typical coaxial port of an equipment box includes a clamping mechanism for clamping the center conductor contact 100′ and establishing an electrical connection therewith.

The center conductor contact 100′ is also supported at its opposite end by a second supporting insulator 2500 of dielectric material which fits into central bore 224′ from the second end 230′ thereof. The outer diameter of the center conductor contact 100 may be selected so that, at any point along its length, given the surrounding dielectric characteristics, and given the diameter of the surrounding inner wall, the characteristic impedance of center conductor contact 100′ will be matched with a desired characteristic impedance of the coaxial cable system (e.g., 75 ohms in a 75-ohm characteristic impedance system).

Spark gap area 600′ is shown in greater detail in the enlarged drawing of FIG. 3A. As indicated in FIG. 3A, the center conductor 100′ includes an enlarged diameter within radial step portion 234′ of inner wall 232′ to facilitate the jumping of a spark across spark gap 601′. The dimensions of the spark gap 601′ are selected to effectively insulate grounded radial step 234′ from center conductor 100′ at normal operating voltages and currents, up to a certain threshold voltage (for example, 1500 Volts). When the surge voltage between center conductor 100′ and outer body 200′ exceeds this threshold voltage, the spark gap 601′ will fire and conduct any excess energy to ground. Such an abnormal power surge might be induced by a lightning strike, for example.

The surge protected coaxial termination 20 also includes a resistive terminating element, resistor 3500, coupled between the center conductor 100 and the grounded outer body 200′. Referring to FIG. 3, axial resistor 3500 is disposed within the central bore 224′ of the outer body 200′. The resistor 3500 is supported within a central bore 246′ of supporting insulator 2500. A first internal electrode 3502 of resistor 3500 is received within a bore 249′ formed in the end of center conductor 100′ that lies within supporting insulator 2500. The electrode 3502 may be soldered to center conductor 100′ before center conductor 100′ and resistor 3500 are inserted into supporting insulator 2500. At the opposite end of the resistor 3500, an external solder electrode 3504 protrudes from the outer face of supporting insulator 3000. The value for resistor 3500 is chosen to be compatible with the characteristic impedance of the coaxial line (e.g., 50 ohms, 75 ohms, etc.). The resistor 3500 is the element that absorbs the RF signal to prevent reflection. The resistor 3500 is preferably chosen to be a carbon composition resistor because such resistors offer good high frequency performance, and also have the ability to withstand the surge current that occurs as the capacitor is alternately charged, and then discharged, during surge protection. As mentioned above, any deviation from the characteristic impedance of the coaxial line can cause RF signal reflection; accordingly, the resistor 3500 is strategically placed on the central axis of the coaxial line structure, and surrounding supporting insulators 2500, 3000, and central bore 224′ of the outer body 200′, are designed to maintain the desired characteristic impedance throughout the length of resistor 3500.

A blocking capacitor 4000 in the form of a so-called “chip capacitor”, extends radially between solder electrode 3504 and a second solder electrode 4500, or grounding post, that extends from a recess formed in outer body 200′. The opposing ends (electrodes) of the blocking capacitor 4000 are soldered to electrodes 3504 and post 4500 in order to electrically couple center conductor 100′ in series with the resistor 3500 and the capacitor 4000 to ground (outer body 200′), in parallel with spark gap 601′. Capacitor 4000 is provided to block DC or AC power from flowing through resistor 3500

Referring now to FIG. 3A, a detail partial cross-sectional view shows the surge protected coaxial termination 30 of FIG. 3. The surge protected coaxial termination includes a spark gap area 600′, a contact 100′, and a body 200′. The contact 100′ includes a cylindrical portion 101′, an enlarged portion 102′ and a cylindrical portion 103′. The body 200′ includes a chamfer 202′, another chamfer 203, an orifice 201, and a spark gap 601′. It was discovered that this configuration actually continued to improve Return Loss performance (exhibiting inverse degradation) over a longer period of time as compared to FIG. 2. However, the change in Return Loss as compared from a virgin state to the first arc was greater than that seen in the configuration of FIG. 2.

Enlarged portion 102′ has an axial length “C” and a diameter “T.” The dimensions may vary depending on application. However, in one particular implementation, the enlarged portion 102′ has an axial length “C” in a range from approximately 0.025″ to approximately 0.06″ and a diameter “T” in the range from approximately 0.05″ to approximately 0.08″. The enlarged portion 102′ may also have a ratio of axial length to diameter from approximately 0.3 to 1 to approximately 1.3 to 1, and in some embodiments a ratio of axial length to diameter from approximately 0.5 to 1 to 1 to 1, and in still further embodiments from approximately 0.6 to 1 to approximately 1 to 1.

Referring now to FIG. 4, a detail partial cross-sectional view illustrates yet another embodiment of a spark gap portion 600″ of a surge protected coaxial termination. The spark gap portion 600″ includes an enlarged portion 102″ of a contact 100″. The enlarged portion 102″ is circumscribed with a plurality of raised ridges 104. In one embodiment, raised ridges 104 may be created by a process known in the industry as knurling. The raised ridges 104 create a plurality of arc points. The arc may concentrate at the areas where the spark gap is smallest and dissipate the center conductor material at that point leaving the next knurl peak to concentrate the arc blast during the next surge event, thus prolonging the life of the terminator over multiple arcing situations.

FIG. 4A depicts a detail partial cross-sectional end view of the embodiment of FIG. 4 useful for illustrating the raised ridges 104 circumscribed on the enlarged portion 102″.

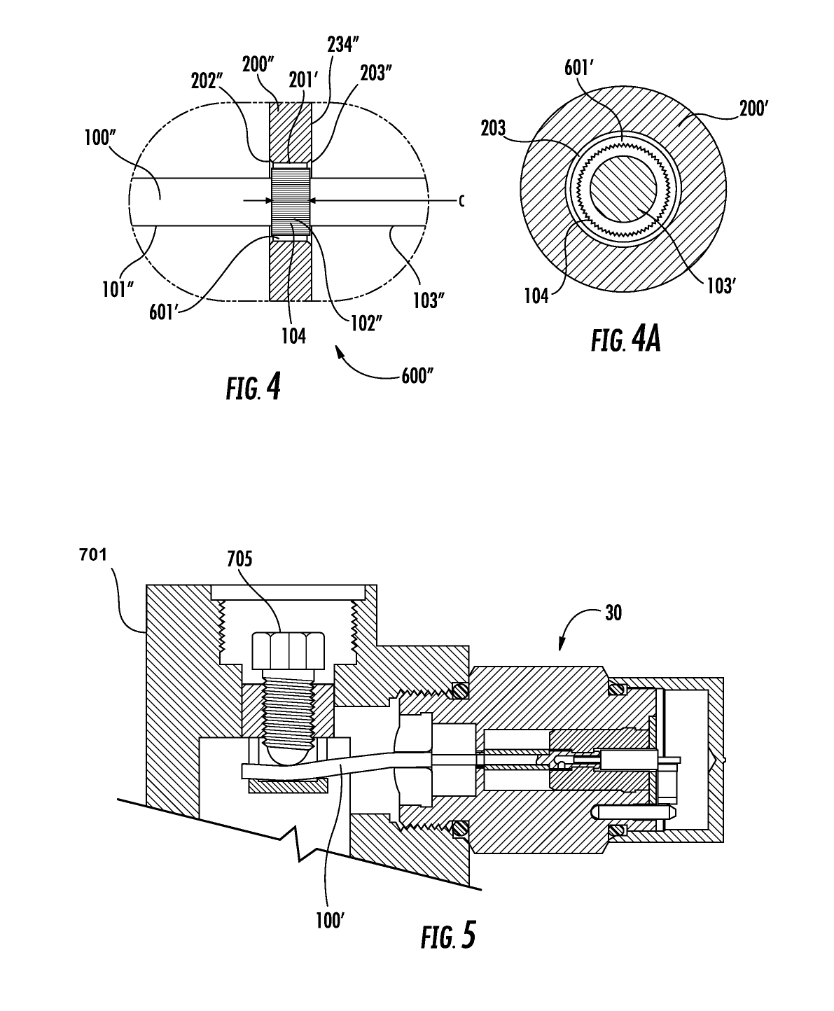

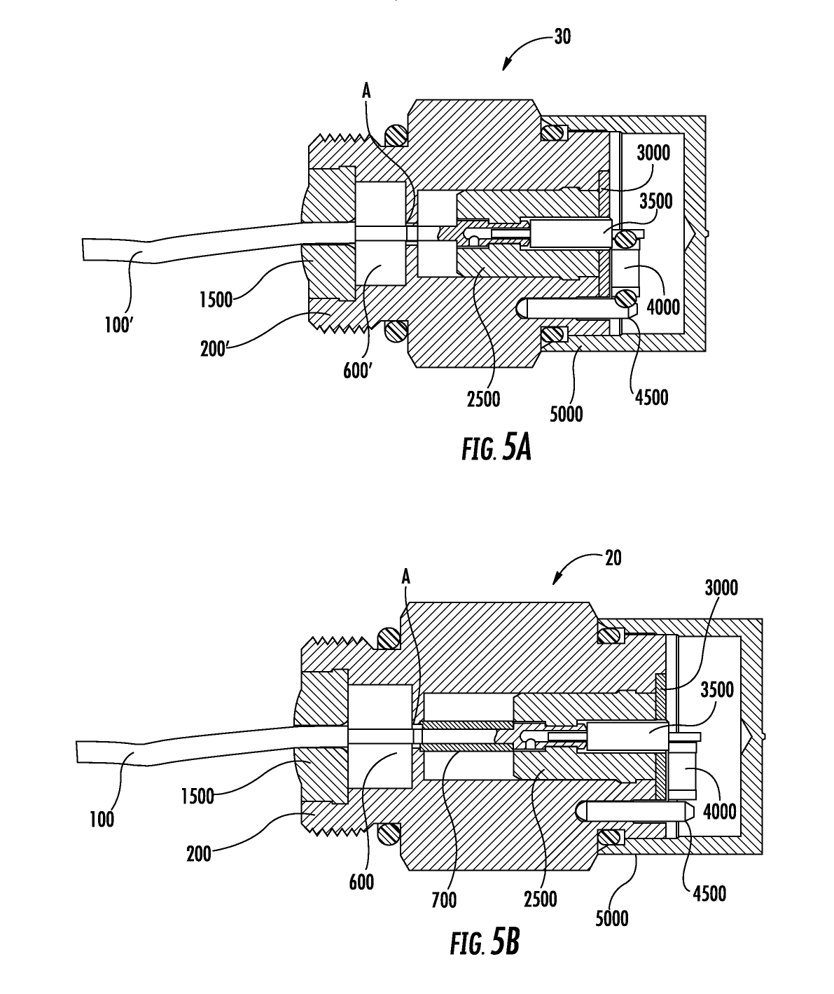

Referring now to FIG. 5, the surge protected coaxial termination 30 shown in FIG. 3 is illustrated mounted in a device 701, such as an amplifier. In the embodiment shown in FIG. 5, the surge protected coaxial termination 30 includes a contact 100′ mounted in the device 701 via a retaining screw 705 (shown fully tightened on contact 100′ in FIG. 5). In extreme conditions of tightening the retaining screw 705 can bend the terminator center conductor 100′ as shown in FIG. 5.

Referring now to FIG. 5A, the surge protected coaxial termination 30 of FIG. 5 is shown. In this implementation, the surge protected coaxial terminator 30 is shown having a bent center conductor 100′ as described with reference to FIG. 5 causing distortion of the center conductor 100′ such that it contacts the body 200′ of the terminator 30 at or near point “A” causing an electrical short circuit.

FIG. 5B illustrates the surge protected coaxial termination 20 shown in FIG. 2 again having a bent center conductor 100. Again, the distortion of the center conductor 100 causes the center conductor 100 to contact the body 200 around point “A” shown in FIG. 5B causing an electrical short circuit.

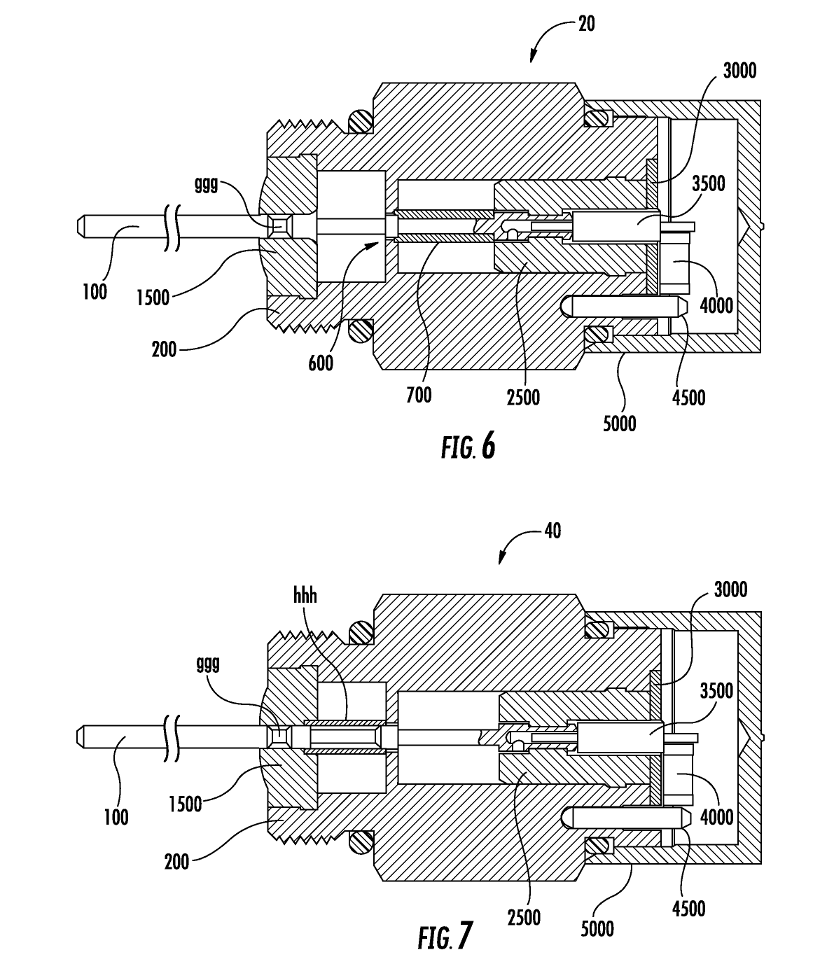

FIG. 6 shows another embodiment of a surge protected coaxial termination 20 including a structural feature ggg, such as a groove, a score or the like providing a mechanical strain relief portion to prevent distortion of the center conductor 100 occurring outside the terminator 20 from translating along the center conductor 100 to the point “A” shown in FIG. 5B.

FIG. 7 shows yet another embodiment of a surge protected coaxial terminator 40 comprising a structural feature ggg, such as a groove, a score or the like, again providing a mechanical strain relief as described with reference to FIG. 6 to prevent distortion of the center conductor 100 from translating to the point “A” as illustrated in FIG. 5B and having an insulator hhh disposed forward of the spark gap area and engaging the insulator 1500 and body 200.

It should now be understood that embodiments described herein are directed to surge protected coaxial connectors. In particular, the surge protected coaxial connectors described herein may include at least one dielectric layer surrounding at least a portion of the central conductor adjacent to a spark gap. In other embodiments, an enlarged portion of the central conductor includes an increased axial length disposed within the spark gap. Furthermore, the embodiments described herein facilitate long term mechanical reliability of surge protected coaxial terminations.

For the purposes of describing and defining the subject matter of the disclosure it is noted that the term “substantially” is utilized herein to represent the inherent degree of uncertainty that may be attributed to any quantitative comparison, value, measurement, or other representation.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that any particular order be inferred.

It will be apparent to those skilled in the art that various modifications and variations can be made without departing from the spirit or scope of the disclosure. Since modifications, combinations, sub-combinations and variations of the disclosed embodiments incorporating the spirit and substance of the disclosure may occur to persons skilled in the art, the embodiments disclosed herein should be construed to include everything within the scope of the appended claims and their equivalents.

1. A surge-protected coaxial termination comprising:
a metallic outer body having a central bore extending therethrough along a longitudinal axis between first and second ends of the metallic outer body, the central bore being bounded by an inner wall having an inwardly-directed radial step extending into the central bore and defining, along with the inner wall:
a first portion of the central bore disposed on a first side of the radial step,
a second orifice portion of the central bore disposed generally at the radial step, and
a third portion of the central bore disposed on a second opposing side of the radial step;
a center conductor extending into the central bore of the metallic outer body and extending into each of the first, second and third portions of the central bore, the center conductor comprising:
a first cylindrical portion disposed at least partially within the first portion of the central bore,
a second central portion disposed at least partially within the second orifice portion of the central bore in close proximity to the radial step of the body to form a spark gap therebetween, and
a third cylindrical portion disposed at least partially within the third portion of the central bore, the third cylindrical portion of the center conductor at least partially surrounded by an insulator layer; and
air within at least a portion of the spark gap formed between the radial step of the body and the second central portion of the center conductor.

2. The surge-protected coaxial termination of claim 1 wherein the wherein third cylindrical portion of the center conductor is disposed within a passage of the insulator layer for at least a portion of the third portion of the central bore.

3. The surge-protected coaxial termination of claim 1 wherein radial step comprises a face and a chamfer adapted to receive and support a longitudinal end of the insulator layer.

4. The surge-protected coaxial termination of claim 3 wherein the insulator layer at least partially reduces breakdown of the second central portion.

5. The surge-protected coaxial termination of claim 1 wherein the radial step comprises a chamfer adjacent the spark gap.

6. The surge-protected coaxial termination of claim 1 wherein the first side of the first portion of the radial step is disposed forward of the central portion of the central bore.

7. The surge-protected coaxial termination of claim 1 wherein the first side of the first portion of the radial step is disposed rearward of the central portion of the central bore.

8. The surge-protected coaxial termination of claim 1 wherein the air comprises an ionizing gas.

9. The surge-protected coaxial termination of claim 1 wherein an effect on termination electrical impedance due to the insulator layer is offset by a lengthening of the bore of the body to tune an RF structure of the termination.

10. The surge-protected coaxial termination of claim 1 wherein the first portion of the central bore has a first inner diameter the and a first axial length, the second orifice portion of the central bore also has a second inner diameter and a second axial length, wherein the second axial length is significantly shorter than the first axial length, and wherein the second inner diameter is significantly smaller than the first inner diameter.

11. The surge-protected coaxial termination of claim 10 wherein the second central portion of the center conductor has a predetermined outer diameter within the second orifice portion of the central bore, the predetermined outer diameter of the center conductor being slightly less than a second inner diameter of the second orifice portion defined by the radial step of the inner wall for positioning the second portion of the inner wall in close proximity to the center conductor to form a spark gap therebetween.

12. The surge-protected coaxial termination of claim 1 wherein the center conductor is comprises a structural mechanical strain relief feature disposed forward of the spark gap.

13. The surge-protected coaxial termination of claim 12 wherein the structural mechanical strain relief feature comprises a groove or a score in the center conductor.

14. The surge-protected coaxial termination of claim 12 wherein the structural mechanical strain relief feature is disposed within a supporting insulator disposed within an annular bore in the body disposed at a front end of the termination.

15. A surge-protected coaxial termination comprising:
a metallic outer body having a central bore extending therethrough along a longitudinal axis between first and second ends of the metallic outer body, the central bore being bounded by an inner wall having an inwardly-directed radial step extending into the central bore and defining, along with the inner wall:
a first portion of the central bore disposed on a first side of the radial step, and
a second orifice portion of the central bore disposed generally at the radial step;
a center conductor extending into the central bore of the metallic outer body and extending into each of the first and second portions of the central bore, the center conductor comprising:
a first cylindrical portion disposed at least partially within the first portion of the central bore, and
a second enlarged central portion disposed at least partially within the second orifice portion of the central bore in close proximity to the radial step of the body to form a spark gap therebetween, the second enlarged central portion of the center conductor having an axial length and a diameter, wherein a ratio of the axial length to the diameter of the second enlarged central portion is in a range from approximately 0.3 to 1 to approximately 1.3 to 1; and
air within at least a portion of the spark gap formed between the radial step of the body and the enlarged central portion of the center conductor.

16. The surge-protected coaxial termination of claim 15 wherein the radial step comprises a chamfer adjacent the spark gap.

17. The surge-protected coaxial termination of claim 15 wherein the air comprises an ionizing gas.

18. The surge-protected coaxial termination of claim 15 wherein the first portion of the central bore has a first inner diameter the and a first axial length, the second orifice portion of the central bore also has a second inner diameter and a second axial length, wherein the second axial length is significantly shorter than the first axial length, and wherein the second inner diameter is significantly smaller than the first inner diameter.

19. The surge-protected coaxial termination of claim 18 wherein the enlarged central portion of the center conductor has a predetermined outer diameter within the second orifice portion of the central bore, the predetermined outer diameter of the center conductor being slightly less than a second inner diameter of the second orifice portion defined by the radial step of inner wall for positioning the second portion of the inner wall in close proximity to the center conductor to form the spark gap therebetween.

20. The surge-protected coaxial termination of claim 15 wherein the center conductor is comprises a structural mechanical strain relief feature disposed forward of the spark gap.

21. The surge-protected coaxial termination of claim 20 wherein the structural mechanical strain relief feature comprises a groove or a score in the center conductor.

22. The surge-protected coaxial termination of claim 20 wherein the structural mechanical strain relief feature is disposed within a supporting insulator disposed within an enlarged annular bore in the body disposed at a front end of the termination.

23. The surge-protected coaxial termination of claim 15 wherein the ratio of the axial length to the diameter of the second enlarged central portion is in a range from approximately 0.5 to 1 to approximately 1 to 1.
